(19) United States
(12) Patent Application Publication
(10) Pub. No.: US 2019/0156440 A1
(43) Pub. Date: May 23, 2019

(54) BLOCKCHAIN-BASED ROOM INVENTORY MANAGEMENT SYSTEM

(71) Applicants: OBOOK HOLDINGS INC., Grand Cayman (KY); OBOOK INC., Taipei City (TW)

(72) Inventors: Chun Kai Wang, Taipei City (TW); Chung Han Hsieh, Taipei City (TW)

(21) Appl. No.: 16/197,150

(22) Filed: Nov. 20, 2018

Related U.S. Application Data
(60) Provisional application No. 62/588,909, filed on Nov. 20, 2017.

(51) Int. Cl. G06Q 50/12; G06Q 10/02; G06Q 10/08; H04L 9/06

(52) U.S. Cl. CPC G06Q 50/12; G06Q 10/02; H04L 2209/38; H04L 9/0637; G06Q 10/087

(57) ABSTRACT

A blockchain-based room inventory management system includes a property management system (PMS) module and an intermediate server system. The PMS module may be under a hotel's direct control. The intermediate server system communicates with at least one online travel agency (OTA) module and/or at least one booking engine using Ethereum-based smart contracts for confirming and processing a room reservation event. If the room reservation event is confirmed to be a successful transaction, the intermediate server system also updates the successful transaction into the PMS module and a blockchain formed by multiple node servers. The blockchain contains multiple blocks arranged in a chronological order for distinguishing successful transactions of different moments. In this way, each successful transaction is prevented from wrongly preceded by a later successful transaction. And the room inventory management system neutralizes an overbooking issue accordingly.

### CROSS-REFERENCE TO RELATED APPLICATION(S)

The application claims priority to U.S. Provisional Application No. 62/588,909, filed on Nov. 20, 2017, entitled “Property management based on Ethereum”, which is incorporated by reference herein in its entirety.

### TECHNICAL FIELD

The present invention relates to a room inventory management system, and more particularly, to a blockchain-based room inventory management system.

### BACKGROUND

Room reservation is a critical service of hotels or travel agencies. In conventional room reservation services, a booking engine or an online travel agency (OTA) represents a hotel and provides a remote user interface to a client for booking an available room of the hotel at a scheduled time.

An OTA indicates a travel website that specializes in the sale of travel products, e.g. hotel room reservations, to clients. The OTA has an online agency agreement with room suppliers (e.g. hotels) to resell their room reservations. Under such condition, the OTA takes payment from the client who reserves at least one available room and pays net rates to the hotels.

A booking engine for hotels' room reservation indicates a website that allows a client to book available room reservations. The booking engine may also introduce customized prices and/or payment rules to a client for an easier decision in room reservation.

However, if more than one client log on the remote user interface for booking a same available room of a hotel in a short period of time, overbooking may easily occur. Overbooking results in significant loss for both sides of the clients and the hotel. For example, overbooking bothers the hotel to arrange additional rooms, services and/or compensations. Also, overbooking forces the client to change his/her travel plan in a limited time and sabotages the client's travel experience. Such inconvenience becomes more frequent and serious in a peak season of traveling. However, the hotel is limited by current OTAs and/or booking engines in processing overbooking in aspect of technology. Therefore, the hotel needs to efficiently neutralize overbooking via technological solutions.

### SUMMARY

This document discloses a blockchain-based room inventory management system. The blockchain-based room inventory management system includes a property management system and an intermediate server system. The property management system includes a host transceiver, a host non-volatile computer-readable memory, and a host computer processor. The host transceiver receives a successful transaction. The host non-volatile computer-readable memory stores a copy of a room inventory record that records availability of all rooms managed by the property management system. The host computer processor updates the copy of the room inventory record by incorporating the successful transaction. The intermediate server system includes a transaction proxy server and a plurality of node servers. The transaction proxy server includes an intermediate transceiver, an intermediate non-volatile computer-readable memory and an intermediate computer processor. The intermediate transceiver receives a room reservation event, forwards the successful transaction to the property management system, and forwards a new block generated in response to the successful transaction. The intermediate non-volatile computer-readable memory stores a plurality of smart contracts generated based on Ethereum, stores the room inventory record implemented using at least one of the plurality of smart contracts, and stores a blockchain that comprises a plurality of blocks. A most recently added block of the blockchain carries all up-to-date successful transactions of the property management system. The intermediate computer processor confirms if the room reservation event will introduce overbooking in the room inventory record. The intermediate computer processor also determines that the room reservation event is successful and generate the successful transaction using information of the room reservation event when the intermediate computer processor confirms that the room reservation event will not introduce overbooking in the local room inventory record. The intermediate computer processor includes a hashing module, a timestamp module and a block generation module. The hash module generates a hash value for the new block in response to the successful transaction. The timestamp module generates a unique timestamp for the new block in response to the successful transaction. The block generation module generates a unique block header for the new block using at least the unique hash value, the unique timestamp and contents of the most recently added block in response to the successful transaction. The block generation module also generates the new block that comprises the unique block header, the information of the successful transaction, at least one of the plurality of smart contracts and the contents of the most recently added block in response to the successful transaction. In addition, the block generation module adds the new block in the blockchain in response to the successful transaction. Each of the plurality of node servers includes a node transceiver, a node non-volatile computer-readable memory and a node computer processor. The node transceiver receives the new block from the intermediate transceiver. The node non-volatile computer-readable memory stores a copy of the blockchain. The node computer processor updates the copy of the blockchain by adding the new block to the copy of the blockchain.

This document also discloses another version of the blockchain-based room inventory management system. The blockchain-based room inventory management system includes a property management system and an intermediate server system. The property management system includes a host transceiver, a host non-volatile computer-readable memory and a host computer processor. The host transceiver receives a successful transaction. The host non-volatile computer-readable memory stores a copy of a room inventory record that records availability of all rooms managed by the property management system. The host computer processor updates the copy of the room inventory record by incorporating the successful transaction. The intermediate server system includes a plurality of node servers. Each of the node servers includes a node transceiver, a node non-volatile computer-readable memory and a node computer processor. The node transceiver receives a room reservation event, forwards the successful transaction to the property management system, and forwards a new block generated in response to the successful transaction. The node non-volatile computer-readable memory stores a plurality of smart contracts generated based on Ethereum. The node non-volatile computer-readable memory also stores a blockchain that includes a plurality of blocks or store a copy of the blockchain. A most recently added block of the blockchain carries all up-to-date successful transactions of the property management system. The room inventory record is implemented using at least one of the plurality of smart contracts stores the room inventory record. The node computer processor updates the stored blockchain or the stored copy of the blockchain by adding a new block to the stored blockchain or the stored copy of the blockchain. The node computer processor includes a hashing module, a timestamp module and a block generation module. The plurality of node servers temporarily elect a master node server among themselves using a consensus algorithm. The node computer processor of the master node server further confirms if the room reservation event will introduce overbooking in the room inventory record. The node computer processor of the master node server also determines that the room reservation event is successful and generates the successful transaction using information of the room reservation event when the node computer processor of the master node server confirms that the room reservation event will not introduce overbooking in the room inventory record. The hashing module of the master node server generates a hash value for the new block in response to the successful transaction. The timestamp module of the master node server generates a unique timestamp for the new block in response to the successful transaction. The block generation module of the master node server generates a unique block header for the new block using at least the unique hash value, the unique timestamp and contents of the most recently added block in response to the successful transaction. Also, the block generation module of the master node server generates the new block that includes the unique block header, the information of the successful transaction, at least one of the plurality of smart contracts and the contents of the most recently added block. In addition, the block generation module of the master node server adds the new block in the blockchain stored in the node non-volatile computer-readable memory of the master node server. The block generation module of the node computer processor of the plurality of node servers other than the master node server, in response to the successful transaction, adds the new block in the copy of the blockchain stored in respectively node non-volatile computer-readable memory.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the present invention is not limited to the precise arrangements and instrumentalities shown.

In the drawings:

FIG. 1 illustrates how a conventional room inventory management system works with OTA modules and/or booking engines for a client to book a room reservation.

FIG. 2 illustrates a blockchain-based room inventory management system according to one embodiment of the present invention.

FIG. 3 illustrates a schematic diagram about data interactions between room inventory records of a host memory, an intermediate memory and node memories of the room inventory management system illustrated in FIG. 2.

FIG. 4 illustrates how an intermediate processor of the room inventory management system illustrated in FIG. 2 generates a new block.

FIG. 5 illustrates a blockchain-based room inventory management system that shifts responsibility of being a master server node among node servers according to one embodiment of the present invention.

FIG. 6 illustrates a schematic diagram about data interactions between room inventory records of a host memory, a temporary master node memory and the other node memories of the room inventory management system illustrated in FIG. 5.

FIG. 7 illustrates how a temporary master processor of the room inventory management system illustrated in FIG. 5 generates a new block.

### DETAILED DESCRIPTION

Reference will now be made in detail to the examples of the invention, which are illustrated in the accompanying drawings. Wherever possible, the same reference numbers will be used throughout the drawings to refer to the same or like parts.

Structure of a Conventional Room Inventory Management System

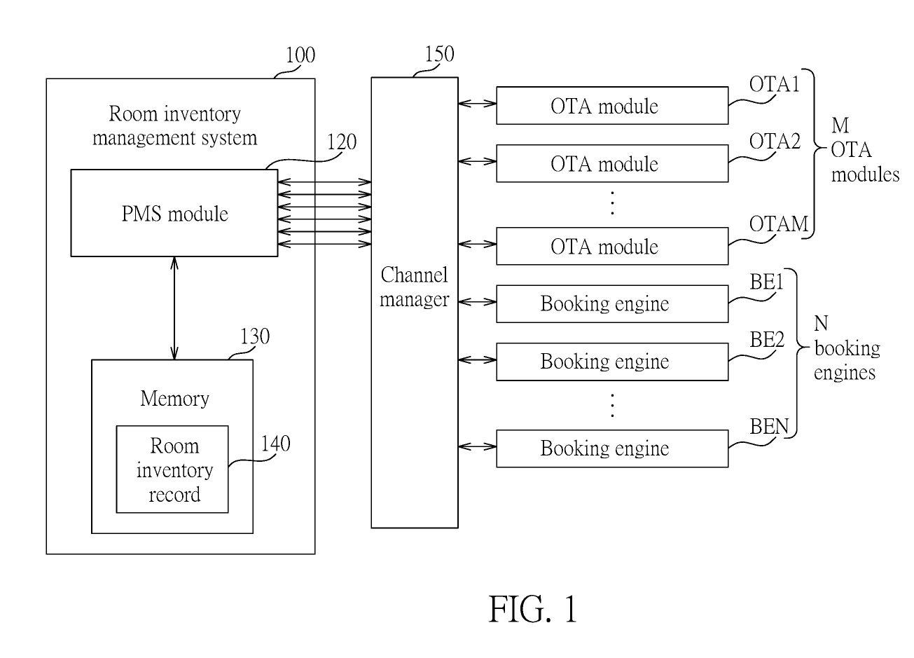

FIG. 1 illustrates how a conventional room inventory management system 100 works with OTA modules and/or booking engines for a client to book a room reservation, via an intermediate channel manager 150 connected in between and under a hotel's control. Exemplarily, the room inventory management system 100 co-works with an amount M of OTA modules OTA1, OTA2, . . . , OTAM and/or an amount N of booking engines BE1, BE2, . . . , BEN, where M and N are positive integers. Please note that at least one of the abovementioned OTA modules and/or booking engines may also be replaced by at least one global distribution system (GDS) and/or at least one metasearch engine. However, hotels' costs of using such GDSs and metasearch engines are extremely higher than those of renting services from OTA modules and/or booking engines. Such costs may include at least constructing and maintaining a customized application programming interface (API) and service fees charged by a number of clients' request. Therefore, ordinary hotels prefer seeking OTA modules' and booking engines' services than seeking GDSs and metasearch engines' services. The following descriptions also focus on utilizing OTA modules and/or booking engines but still apply for conditions that utilize GDSs and metasearch engines' services.

The room inventory management system 100 is disposed in a domain that is under a hotel's control. The OTA modules OTA1, OTA2, . . . , OTAM and/or the booking engines BE1, BE2, . . . , BEN are disposed in a remote place from the hotel and not under the hotel's control. The channel manager 150 respectively maintains a communication channel with each one of the OTA modules OTA1, OTA2, . . . , OTAM and the booking engines BE1, BE2, . . . , BEN for translating and relaying their requests to the room inventory management system 100, i.e., a hotel. However, under common circumstances, each of the OTA modules OTA1, OTA2, . . . , OTAM and/or the booking engines BE1, BE2, . . . , BEN utilizes different APIs and communication protocols to deliver different types of variables and parameters. Therefore, it always increases the hotel or the channel manager 150's costs in designing customized APIs for the channel manager 150's communication channels for fitting the OTA modules OTA1, OTA2, . . . , OTAM and/or the booking engine BE1, BE2, . . . , BENs' APIs and communication protocols.

The room inventory management system 100 includes a conventional property management system (PMS) module 120 and a memory 130.

A conventional PMS module for hotels' room reservation indicates a computerized system that facilitates a hotel's room reservation. The conventional PMS module is a comprehensive software application used to cover objectives like coordinating the operating functions of a hotel's front office, sales, planning, reporting, and etc. The conventional PMS module automates hotel operations like guest bookings, guest details, online reservations, posting of charges, point of sale, telephone, accounts receivable, sales and marketing, events, food and beverage costing, materials management, HR and payroll, maintenance management, quality management and other amenities. A hotel's PMS module may have integrated or interfaced with third-party solutions like central reservation systems and revenue or yield management systems, online booking engine, back office, point of sale, door-locking, housekeeping optimization, energy management, payment card authorization and channel management systems. With the aid of cloud computing technologies, a hotel's PMS module expands its functionality to guest-facing features, such as online check-in, room service, in-room controls, guest-staff communication, virtual concierge, and etc. The expanded functionalities are mainly used by guests on their own mobile phones or such provided by the hotel in lobbies and/or rooms. A conventional PMS module always needs to give accurate and timely information on the basic key performance indicators of a hotel business such as average daily rate or occupancy rate. The conventional PMS module also helps the food and beverage management control the stocks in the store room and decide what to buy, how much and how often. In this way, the conventional PMS module 120 enables a client to complete his/her room reservation with the hotel locally via the PMS module 120 or remotely via the abovementioned OTA modules and/or booking engines.

The memory 130 keeps a room inventory record 140 that stores availability of all rooms managed by the room inventory management system 100, i.e., managed by the hotel. According to the managed rooms' availability, the managed rooms may be classified into available rooms, reserved rooms and occupied rooms managed by the room inventory management system 100. When a client reserves an available room, the available room becomes a reserved room. When the client checks-in the hotel for the reserved room, the reserved room become an occupied room. When the client checks-out from the hotel, the occupied room becomes an available room.

Similarly, each of the OTA modules OTA1, OTA2, . . . OTAM has a respective room inventory. And each of the booking engines BE1, BE2, . . . , BEN has a respective room inventory record.

However, the OTA modules OTA1, OTA2, . . . OTAM and booking engines BE1, BE2, . . . , BEN are not motivated to dynamically synchronize contents of respective room inventory records with contents of the room inventory record 140. It is because such dynamic synchronization may significantly increase their burden of waiting for the conventional PMS module 120's response. Besides, since the channel manager 150 is merely responsible for translating and relaying requests, the channel manager 150 cannot relieve the conventional PMS module 120 of such burden. More seriously, if more and more the OTA modules and booking engines keep polling the contents of the room inventory record 140, the conventional PMS module 120 will not be affordable to such polling and lead to its system crash. For avoiding such system crash, the conventional PMS module 120 may only allow limited polling for each of the OTA modules and booking engines by giving larger intervals of waiting time, from at least several minutes to several hours depending on how many OTA modules and/or booking engines that the hotel seeks service to. For example, an OTA or a booking engine may be limited to poll the room inventory record 140 by every half to two hours if there are over five OTA modules and/or booking engines that the hotel seeks service to. Such waiting time may be longer when the hotel cooperates with more OTAs and/or booking engines or during a peak season of traveling. As a result, inconsistency may inevitably occur between contents of the room inventory record 140 and the room inventory record of the OTA modules and/or booking engines because the OTA modules and/or booking engines may not have correct room inventory record while dealing with a client's room reservation request. Even under some extreme circumstances, for decreasing undesirable burden for both sides and focusing on dealing with incoming room reservation requests, the OTAs and/or the booking engines may intend to skip polling the conventional PMS module 120 at times or even frequently for saving its cost of room inventory confirmation. Worse of it, if the hotel actually runs out of available rooms and the OTA modules and/or booking engines fail to timely poll the conventional PMS module 120 for being aware, overbooking becomes inevitable.

### How Overbooking Occurs in a Conventional Room Inventory Management System

How overbooking occurs in aspect of conventional technology will be further introduced in detail via references to FIG. 1.

Assume that a first client accesses the PMS system 120 via the OTA module OTA1 to reserve an available room R1 managed by the room inventory management system 100. First, the OTA module OTA1 checks its own room inventory record, which may not be consistent with the room inventory record 140, for confirming if the hotel has available rooms. If so, the OTA module OTA1 forwards the first client's room reservation request to the conventional PMS module 120. The conventional PMS module 120 then checks the room inventory record 140 to confirm if it does have available room for the first client. If so, the conventional PMS module 120 translates the first client's room reservation request to be a successful transaction and updates the room inventory record 140 to record the successful transaction. Such update includes changing availability of the room R1 to be “reserved” and decreases an available room amount of the hotel.

However, if a second client accesses the conventional PMS module 120 via the booking engine BE1 for reserving the same room R1 slightly after the first client's room reservation, such that the booking engine BE1 can not be timely informed of the first client's successful transaction, the booking engine BE1 may mistakenly confirm that the room R1 is still available. The booking engine BE1 then forwards the second client's room reservation request to the conventional PMS module 120. Apparently, the conventional PMS module 120 will soon determine that the second client's room reservation is unsuccessful after referencing the room inventory record 140 but have to wait the booking engine BE1 ‘s next polling to inform the second client's unsuccessful room reservation. If unfortunately, the second client checks-in the hotel before the booking engine BE1’ s next polling, he or she and the hotel will confront an overbooking issue.

If the second client is lucky enough, the hotel may still arrange an alternative available room for him/her with some satisfiable compensation. However, if the hotel runs out of its available rooms after confirming the first client's successful transaction, the second client will still face the overbooking problem and be forced to immediately search for another available room at another hotel. Under great uncertainty, the second client's travel experience is highly likely sabotaged, and it always backfires both the hotel and the book engine BE1's credit. Worse of it, as mentioned above, if the hotel cooperates with more OTAs and/or booking engines, or if it is under a peak traveling season, severity of the overbooking problem will keep on multiplying itself.

In aspect of technology, the conventional room inventory management system 100 has the following defects:

(1) The OTA modules and the booking engines cannot dynamically poll the conventional PMS module 120 for confirming correctness of respective room inventory records.

(2) If the OTA modules and the booking engines increase respective frequency of polling on the conventional PMS module 120, the conventional PMS module 120 will not be affordable to its own loading of computation and/or communication bandwidth. Therefore, computational or communicative error may occur more easily.

(3) Data inconsistence between the conventional room inventory management system 100 and the OTA modules and/or booking engines result in overbooking of the hotel. Such overbooking is getting worse when the hotel cooperates with more OTA modules and/or booking engines or during a peak traveling season.

(4) The hotel has to cost more in developing customized APIs and communication protocols in receiving required variables and parameters from the OTA modules and/or booking engines to handle room reservation requests, or even room cancellation requests or room checkout requests.

### Room Inventory Management System of the Present Invention

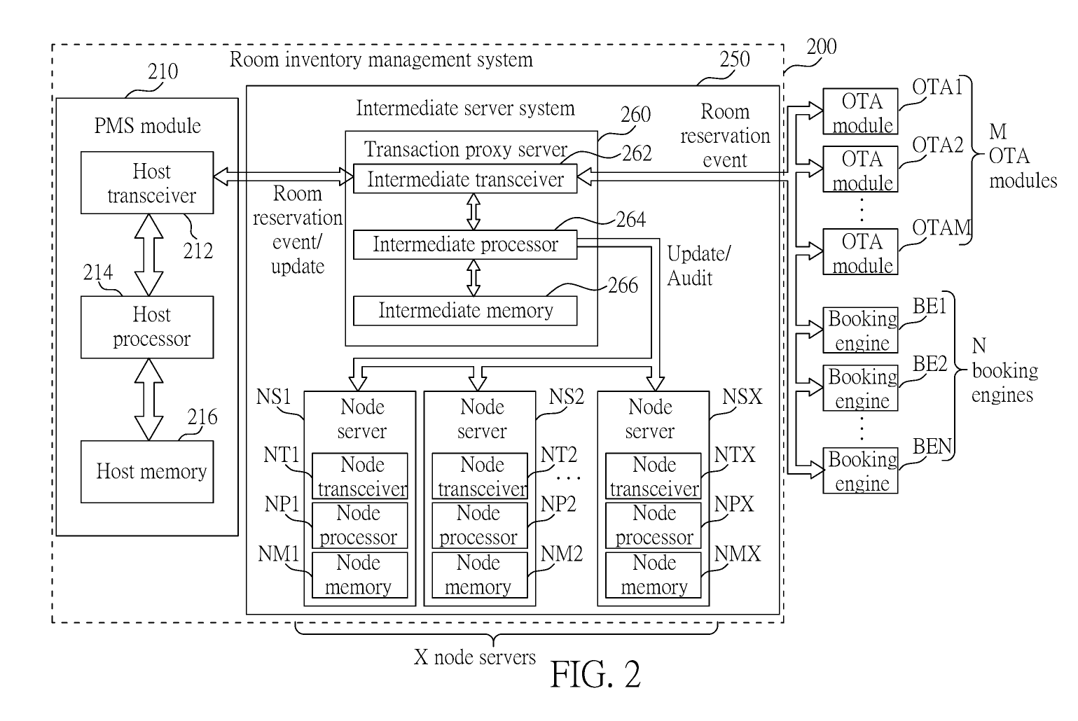

For effectively neutralizing the overbooking problem occurred in the conventional room inventory management system 100, the present invention discloses a blockchain-based room inventory management system according to one embodiment, i.e., a blockchain-based room inventory management system 200 illustrated in FIG. 2. The room inventory management system 200 introduces an intermediate server system capable of neutralizing the data inconsistence between the conventional PMS module and the OTA modules and/or booking engines and capable of relieving the burden of the conventional PMS system. Also, the room inventory management system 200 provides a cost-effective solution to hotels in saving communication and maintenance costs from the OTA modules, booking engines, and even from the abovementioned GDSs and metasearch engines.

A blockchain contains multiple physical nodes, each of which theoretically keeps same contents, e.g., a plurality of blocks. Each the node contains multiple blocks. In response to occurrence of a specific event, e.g. a successful transaction, a new block is generated for recording the specific event. With more and more blocks generated, a history of successful transactions can be established and even traced in the blockchain. So, the first advantage of applying the blockchain is traceability. On top of that, if an act of tampering a specific block at a specific physical node succeeds, since all the physical nodes contain theoretically-same contents, i.e., same blocks, such act can be easily detected and fixed by referencing to the other unaffected physical nodes. That is, the second advantage of applying a blockchain is its capability of defending tampering acts.

While applying the Blockchain technologies, the blockchain-based room inventory management system 200 is capable of effectively securing correctness of each successful transaction, i.e., a room reservation event. Therefore, the blockchain-based room inventory management system 200 can effectively neutralize the overbooking issue caused by applying a conventional room inventory management system.

Also, the blockchain-based room inventory management system 200 utilizes Ethereum-based smart contracts to generate a common application programming interface (API) and/or a common communication protocol for communications with the OTA modules and/or the booking engines. In some examples, the common API is for those OTA modules and/or the booking engines which are also Ethereum-based, and the common communication protocol is for those OTA modules and/or the booking engines which are not Ethereum-based. In this way, costs of the API and/or communication protocols for system maintenance and communications that include transmitting room reservation events or updating room inventory records with the OTA modules and/or the booking engines can also be significantly decreased. It is because of Ethereum-based smart contracts' open and easy properties in language designs, including relaying fewer or more understandable variables and parameters. Such cost reduction also works while the blockchain-based room inventory management system 200 works with GDSs and metasearch engines for the same reasons.

Smart contract is a technology developed under Ethereum, which is an important auxiliary technology for the blockchain technologies that are applied in the present invention. Ethereum is an open-source and blockchain-based distributed computing system and operating system featuring smart contract functionality. Ethereum provides a decentralized Turing-complete virtual machine, the Ethereum virtual machine (EVM), which can execute scripts using an international network of nodes.

Ethereum's smart contracts are based on different computer languages, which developers use to program their own functionalities. Smart contracts are high-level programming abstractions that are compiled down to Ethereum Virtual Machine (EVM) bytecode and deployed to the Ethereum blockchain for execution. Smart contracts can open up the possibility to prove functionality, e.g. self-contained provably fair casinos. Ethereum blockchain applications are often referred to as decentralized applications, since they are based on the decentralized EVM, and its smart contracts. Examples of Ethereum blockchain applications include: digital signature algorithms, securitized tokens, digital right management, crowdfunding, prediction markets, remittance, online gambling, social media platforms, financial exchanges and identity systems. Because of the Turing-complete property of Ethereum, smart contracts provide high flexibilities in function designs and implementations. Moreover, since Ethereum-based smart contracts are open sources and are easy to implement, the blockchain-based room inventory management system 200 takes the abovementioned advantages in communications with the OTA modules and/or the booking engines with the aid of the Ethereum-based smart contracts.

The blockchain-based room inventory managing system 200 includes a novel PMS module 210 and an intermediate server system 250. The PMS module 210 may be disposed within a hotel such that the hotel can control the PMS module 210 directly. The intermediate server 250 may be disposed remotely from the PMS module 210. In one example, the intermediate server system 250 pre-processes or processes room reservation events for the PMS module 210, such that the intermediate server system 250 significantly relieves the PMS module 210's loading. In one example, the room reservation events include at least internal room reservation requests and internal room cancellation/checkout requests from the hotel, and external room reservation requests and room cancellation requests from the OTA modules and/or booking engines. The external room reservation/cancellation requests may be transmitted from external OTA modules and/or booking engines to reserve or cancel at least one room of the hotel with the aid of the API or the communication protocol developed using the Ethereum-based smart contracts. The internal room reservation/checkout requests occur when a client directly reserves a room in the hotel or when a checked-in client of the hotel decides to checkout. Also, the intermediate server system 250 utilizes the Ethereum-based smart contracts to communicate room reservation events for a cost-effective communication with the OTA modules and/or booking engines since APIs and communication protocols developed using the Ethereum-based smart contracts are easy to design.

In one example, the PMS module 210 is specifically designed to cooperate with the intermediate server system 250 by sharing a same application programming interface, i.e., a same remote procedure call (RTC) procedure, such that communications between the PMS module 210 and the intermediate server system 250 may take shorter processing time and become more efficient. Such efficiency becomes more obvious when the room inventory management system 200 needs to handle a huge amount of room reservation events in a short period of time, e.g., during a peak traveling season.

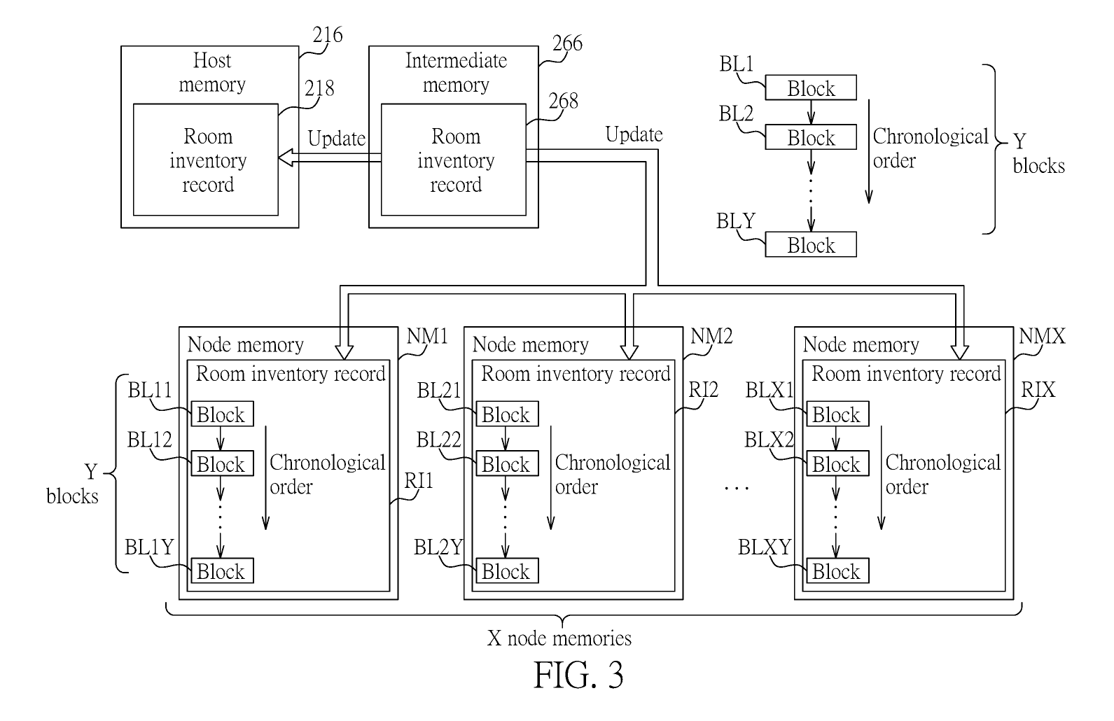

The PMS module 210 includes a host transceiver 212, a host processor 214 and a host memory 216. The host processor 214 is a computer processor, and the host memory 216 is a non-volatile computer-readable memory in examples of the present invention. The host transceiver 212 can handle communications with the intermediate server system 250 but doesn't directly communicate with the OTA modules OTA1, OTA2, . . . , OTAM and/or booking engine BE1, BE2, BEN. The host memory 216 keeps a room inventory record 218 (shown in FIG. 3) for the PMS module 210 for the hotel's room management. The room inventory record 218 includes at least availability of each room of the hotel and a count of available rooms of the hotel. The host processor 214 is capable of referencing and/or updating the room inventory record 218 in response to an occurrence of a room reservation event. For example, the host processor 214 decreases the count of available rooms and/or deactivates availability of a to-be-reserved room in response to a room reservation request. The host processor 214 may also increase the count of available rooms and/or activate availability of a reserved room in response to a room cancellation request or a room checkout request.

The intermediate server system 250 applies the blockchain technologies. Also, the intermediate server system 250 includes a transaction proxy server 260 and a plurality of node servers, for example, an amount X of node servers NS1, NS2, . . . , NSX shown in FIG. 2, where X is a positive integer. The node servers NS1, NS2, . . . , NSX also form a blockchain and keeps substantially same data for respective data consistency and data traceability.

The transaction proxy server 260 acts as the brain of the intermediate server system 250 and includes an intermediate transceiver 262, an intermediate processor 264 and an intermediate memory 266. In some examples, the transaction proxy server 260 acts as a trusted node that is authorized to generate blocks in the blockchain formed within the intermediate server system 250. Similarly, in examples, the intermediate processor 264 is a computer processor, and the intermediate memory 266 is a non-volatile computer-readable memory. When anyone of the OTA modules OTA1, OTA2, . . . , OTAM and booking engine BE1, BE2, . . . , BEN or the PMS module 210 issues a room reservation request, the intermediate transceiver 262 receives the room reservation request and forward it to the intermediate processor 264. In some examples, the intermediate transceiver 262 is implemented as an application programming interface (API) server, and the API server is used for, based on the Ethereum-based smart contracts stored in the intermediate memory 266, translating the room reservation request into a form that the PMS module 210 and the intermediate server system 250 can easily understand, i.e., replacing functions of the channel manager 150. The intermediate memory 266 keeps a room inventory record 268 (shown in FIG. 3) that are implemented using at least one of the Ethereum-based smart contracts, such that the intermediate processor 262 operates (e.g. accesses, updates, or audits) the room inventory record 268 based on instructions compatible to the plurality of Ethereum-based smart contracts. The communications between the intermediate server system 250 (or specifically the transaction proxy server 260) and the OTA modules OTA1, OTA2, . . . , OTAM and/or the booking engines BE1, BE2, . . . , BEN are supported by the smart contracts stored in the intermediate memory 266. The intermediate processor 264 utilizes at least one of the plurality of smart contracts to access and/or update contents of the room inventory record 268. In some examples, the intermediate transceiver 262 may also be remotely disposed from the intermediate processor 264 and/or the intermediate memory 266 for dislocating the API server's translation procedures from room inventory management procedures to avoid system overloading of the transaction proxy server 260.

In some examples, the intermediate processor 264 determines whether a room reservation event, which may be a room reservation request, a room checkout request, or a room cancellation request from the PMS module 210 or anyone of the OTA modules OTA1, OTA2, . . . , OTAM or the booking engines BE1, BE2, . . . , BEN, is a successful transaction. The room reservation event from anyone of the OTA modules OTA1, OTA2, . . . , OTAM or the booking engines BE1, BE2, . . . , BEN may be an external room reservation request or an external room cancellation request (if a reservation has been confirmed to be successful) from a client. The room reservation event from the PMS module 210 may be an internal room reservation request, an internal room cancellation request, or an internal room checkout request. Upon receiving a room reservation request, the intermediate processor 264 checks the room inventory record 268 to confirm if the room reservation request can be allowed, for example, according to availability of a requested room or if allowance of the room reservation request will cause overbooking in the hotel. If the intermediate processor 264 allows the room reservation request, the intermediate processor 264 generates a successful transaction correspondingly. Similarly, upon receiving an internal checkout request, an internal room cancellation request, or an external room cancellation request, the intermediate processor 264 checks the room inventory record 268, releases the cancelled or checked-out room, and generates a successful transaction accordingly.

For supporting complicated functions run under the blockchain technologies, the intermediate server system 250 applies at least one Ethereum-based smart contract stored in the intermediate memory 266. As mentioned before, with the aid of smart contracts' flexibility in designing and implementing functions, the intermediate server system 250 is capable of performing various types of functions in combination of traditional room reservation requirements and most updated blockchain technologies.

In some examples, after the intermediate processor 264 determines whether the room reservation event is a successful transaction, the intermediate processor 264 incorporates the successful transaction into the room inventory record 268 for updating the room inventory record 268. Also, the intermediate processor 264 may synchronize contents of the updated room inventory record 268 to each one of the node servers NS1, NS2, . . . , NSX, i.e., update the blockchain formed by the node servers NS1, NS2, . . . , NSX. Therefore, the node servers NS1, NS2, . . . , NSX may act as backup storages for the room inventory record 268.

In some examples, as the well-known blockchain technologies demonstrates, the above block updates of the node servers NS1, NS2, . . . , NSX may include the block competitions between different node servers in a same blockchain, such that some blocks are added and then abandoned in part of the node servers NS1, NS2, . . . , NSX. However, the block updates of the node servers NS1, NS2, . . . , NSX are assumed to cover such block competitions for brevity. Therefore, each the node server NS1, NS2, . . . , NSX is assumed to have substantially same blocks that contain substantially same transaction history in the end.

As such, the contents of the room inventory record 268 can be better prevented from being sabotaged because the intermediate processor 264 can always find a precise copy of the room inventory record 268 from anyone of the node servers NS1, NS2, . . . , NSX.

Each of the node servers NS1, NS2, . . . , NSX has a node transceiver, a node processor and a node memory. The node processor is a computer processor. And the node memory is a non-volatile computer-readable memory. The node transceiver may receive instructions from and transmit data to the intermediate processor 264 when a successful transaction corresponding to a room reservation request occurs. The node memory may store a copy of contents of the room inventory record 268 for future updates and/or auditing. The node processor may process instructions received from the intermediate processor 264 and determine what data to respond to the intermediate processor 264. As exemplarily illustrated in FIG. 2, for example, the node server NS1 has a node transceiver NT1, a node processor NP1 and a node memory NM1; the node server NS2 has a node transceiver NT2, a node processor NP2 and a node memory NM2; and the node server NSX has a node transceiver NTX, a node processor NPX and a node memory NMX.

FIG. 3 illustrates a schematic diagram about relations between room inventory records of the host memory 216, the intermediate memory 266 and node memories NM1, NM2, . . . , NMX, i.e., the room inventory record 218, the room inventory record 268, and room inventory records RIL RI2, . . . , RIX. Each of the node memories NM1, NM2, . . . , NMX stores a same plurality of smart contracts as those of the room inventory record 268. And the room inventory records RI1, RI2, . . . , RIX are also implemented using the plurality of smart contracts stored in respective node memories NM1, NM2, . . . , NMX. Similar as the intermediate processor 264 and the intermediate memory 266, each of the node processor NP1, NP2, . . . , NPX respectively accesses and updates contents of the room inventory records RI1, RI2, . . . , RIX using the plurality of smart contracts that implement the room inventory records RI1, RI2, . . . , RIX.

In some examples, the intermediate processor 264 first updates the room inventory record 268 in response to occurrence of a successful transaction. Also, the intermediate processor 264 forwards the updated contents of the room inventory record 268 to the PMS module 210 via the host transceiver 212, such that the host processor 214 updates the room inventory record 218 to be synchronous with the updated contents of the room inventory record 268. The intermediate processor 264 also generates a new block that keeps at least all up-to-date successful transactions of the PMS module 212, in response to the updated contents of the room inventory record 268. In some examples, the intermediate processor 264 requires at least one smart contract stored in the intermediate memory 266 for executing complete instructions, such as calculating and updating variables, to generate the new block. For example, upon Y different successful transactions occurring in a chronological order, the intermediate processor 264 may generate a block BL1 at a moment t1, a block BL2 at a moment t2, . . . , and a most recently-generated block BLY at a moment tY, where Y is a positive integer. The moment t1 is earlier than the moment t2, the moment t2 is earlier than the moment t(Y−1), and the moment t(Y−1) is earlier than the moment tY. The moment tY indicates a most-recent successful transaction that occurs at the moment tY. The block BL1 includes all up-to-date successful transactions until the moment t1. The block BL2 includes one more successful transaction occurring at the moment t2 than the block BL1, i.e., the block BL2 includes all up-to-date successful transactions until the moment t2. Similarly, the block BLY includes all up-to-date successful transactions until the moment tY.

Each of the node server NS1, NS2, . . . , NSX is obligated to keep respective room inventory records RI1, RI2, . . . , RIX synchronously updated with contents of the room inventory record 268 under the blockchain technologies. Therefore, after receiving the most recent generated block BLY via respective node transceivers NT1, NT2, . . . , NTX, the node processors NP1, NP2, . . . , NPX respectively incorporate the most recent generated block BLY into respective room inventory records RI1, RI2, . . . , RIX. In some examples, the node processors NP1, NP2, . . . , NPX require at least one smart contract's assistance to synchronously execute instructions involved in the most recent transaction for completing the updates in respective room inventory records RI1, RI2, . . . , RIX. The updates may include updating certain local variables or certain global variables. The certain local variables may include room availabilities or respective room prices. The certain global variables may include conditional discounts or a dynamically-adjusted room price.

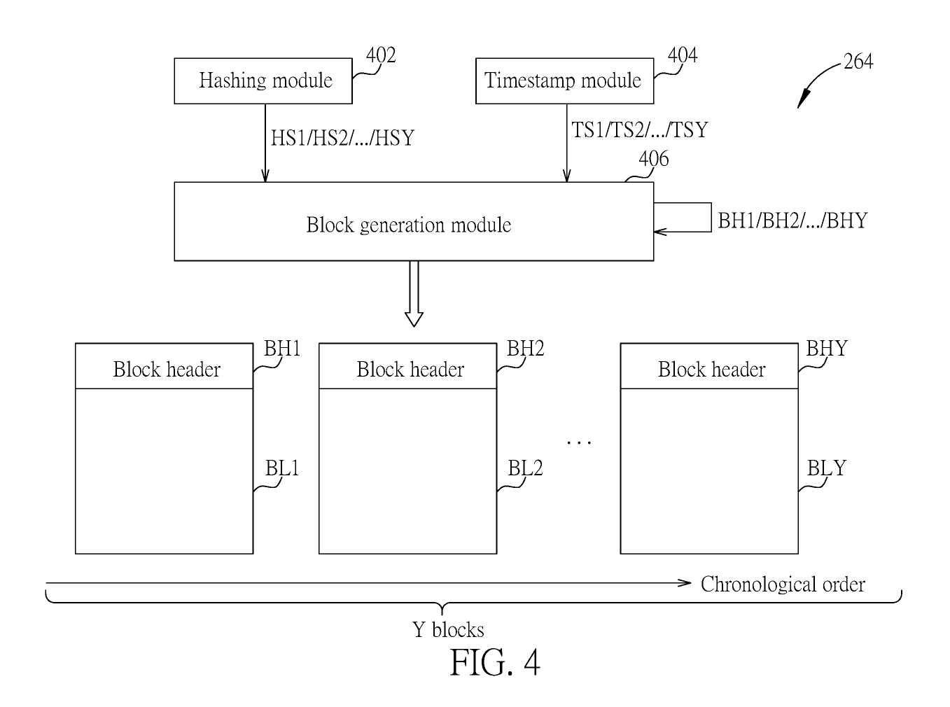

FIG. 4 illustrates how the intermediate processor 264 generates a new block in detail. The intermediate processor 264 includes a hashing module 402, a timestamp module 404 and a block generation module 406. As mentioned before, the intermediate processor 264 generates a new block in response to a successful transaction. Upon the intermediate processor 264 confirms the successful transaction, the hashing module 402 generates a hash value for the new block, and the timestamp module 404 generates a unique timestamp for the new block. For example, the hashing module 402 generates Y substantially unique hash values HS1, HS2, . . . , HSY, and the timestamp module 404 generates Y substantially unique timestamps TS1, TS2, . . . , TSY respectively for the Y blocks BL1, BL2, . . . , BLY.

Methods of generating a hash value are well known for those who are skilled in the blockchain technologies, therefore, such methods are not specifically introduced herein. However, each generated hash value has its randomness, such that each generated hash value can substantially be unique. In some examples, the generated timestamp may be referred as the moment when the intermediate processor 264 confirms the successful transaction or when the room reservation request is initiated, for example, by the PMS module 210 or anyone of the OTA modules OTA1, OTA2, . . . , OTAM, or the booking engines BE1, BE2, . . . , BEN. In this way, each the block BL1, BL2, . . . , BLY should have its substantially unique hash value and substantially unique timestamp. And the most recently-generated block BLY has a latest timestamp among all the up-to-date generated blocks.

The block generation module 406, in response to the successful transaction, incorporate the substantially unique hash value from the hashing module 402 and the substantially unique timestamp from the timestamp module 404 for generating a block header. For example, the block generation module 406 incorporates the hash value HSY and the timestamp TSY to generate a block header BHY for the to-be-generated block BLY upon a most recent successful transaction. In this way, the block generation module 406 respectively generates block headers BH1, BH2, . . . , or BHY.

In addition, the block generation module 406, in response to the successful transaction, generates a new block that incorporates a corresponding block header, contents of the successful transaction, at least one smart contract, and contents of a directly-preceding generated block. For example, in response to a most recent successful transaction, the block generation module 406 generates the block BLY that includes the block header BHY, at least one smart contract loaded from the intermediate memory 266, and contents of a directly-preceding block BL(Y−1) (not illustrated for brevity). In this way, the most recently-generated block BLY includes contents of all previously generated blocks BL1, BL2, . . . , BL(Y−1). Also, all up-to-date successful transactions indicated by all the previously generated blocks BL1, BL2, . . . , BL(Y−1) can be easily audited by just referencing the most recently-generated block BLY.

Last, the block generation module 406 adds the new block into the blockchain formed by the node servers NS1, NS2, . . . , NSX to update the blockchain. For example, the block generation module 406 adds the most recently-generated block BLY into the blockchain that already contains blocks BL1, BL2, . . . , BL(Y−1) for updating the blockchain.

In some examples, each of the OTA modules OTA1, OTA2, . . . , OTAM and/or the booking engines BE1, BE2, . . . , BEN is allowed to, directly or via the transaction proxy server 260, access the blockchain formed by the node servers NS1, NS2, . . . , NSX. In this way, with the aid of the utilized blockchain that always keeps substantially the most recent transaction, each of the OTA modules OTA1, OTA2, . . . , OTAM and/or the booking engines BE1, BE2, . . . , BEN can always initiatively confirm the correct count of available rooms and/or availability of a specific room by referencing a most recent generated block in a timelier manner. As a result, overbooking can be substantially neutralized.

Besides, since most tasks of the PMS module 210 is relieved by the intermediate server system 250, the conventional defects of the PMS module's overloading can also be effectively and substantially avoided.

In some examples, blocks of the blockchain formed by the node servers NS1, NS2, . . . , NSX are built and audited via respective block headers, more specifically, via respective hash values. In some examples, the blockchain among the node servers NS1, NS2, . . . , NSX applies the Merkle Tree technology, such that each block of the blockchain has a substantially unique Merkle Root. If a specific block, for example the block BL1, is tampered in one of the node servers NS1, NS2, . . . , NSX, any entity which can access the blockchain can easily audit the blockchain and find the tampered block BL1 on the specific node server. The auditing procedure includes: (1) calculating a Merkle root for the block BL1 on each the node servers NS1, NS2, . . . , NSX; (2) comparing Merkle roots of all the blocks BL1 on the node servers NS1, NS2, . . . , NSX to find inconsistences on the tampered blocks BL1 on at least one node server. More specifically, since the tampered block BL1 must have a different Merkle root from those of untampered blocks BL1 on the other node servers, the different Merkle root can be easily found by the abovementioned comparison. The tampered block BL1 can also be fixed by referencing to the other untampered blocks BL1 on the other node servers. As a result, blocks on the blockchain are ensured of respective correctness, such that the room inventory records on each the node server can be secured. In some examples, an entity is authorized to access the blockchain, such as the processor of the PMS module 210, the transaction proxy server 260, or anyone of the node servers NS1, NS2, . . . , NSX for auditing or even fixing the blockchain. The above example of auditing and fixing also works for blocks other than the exemplary block BL1.

In some examples, each successful transaction can be precisely traced, which is part of the above auditing procedure, by referencing to anyone of the blocks BL1, BL2, . . . , BLY on anyone of the node servers NS1, NS2, . . . , NSX via respective block headers, more specifically, via respective timestamps. The tracing procedure can also be performed using at least one auditing smart contract stored in the intermediate memory 266 or each of the node memories NM1, NM2, . . . , NMX by an entity that is authorized to access the blockchain as mentioned above. Such entity may include the intermediate processor 264 of the transaction proxy server 260 or a node processor of anyone of the node servers NS1, NS2, . . . , NSX. Preferably, such auditing procedure is conducted by the intermediate processor 264 for immediate and non-confusing updates. The tracing procedure includes: (1) Search for block headers BH1, BH2, . . . , BHY of the blocks BL1, BL2, . . . , BLY; (2) Trace the timestamps TS1, TS2, . . . , TSY of each of the blocks BL1, BL2, . . . , BLY for distinguishing each successful transaction that initiates each of the blocks BL1, BL2, . . . , BLY. With the aid of the timestamps TS1, TS2, . . . , TSY, occurrences of each the successful transactions can be precisely confirmed in a chronological order. In this way, overbooking caused by mistakenly accepting a later successful transaction instead of an earlier successful transaction, which may not be timely informed to an OTA module or a booking engine, can be better confirmed and avoided.

In some examples, the plurality of smart contracts stored in the room inventory record 268 includes at least one dynamic pricing smart contract that are capable of determining at least one temporary and variable room price according to a temporary available room amount recorded in the room inventory record 268. The intermediate processor 264 dynamically adjusts the temporary room price and forwards the adjusted room price to the PMS module 210, the OTA modules OTA1, OTA2, . . . , OTAM, and/or the booking engines BE1, BE2, . . . , BEN via the intermediate transceiver 262. Similarly, after the host transceiver 212 receives the adjusted room price, the host processor 214 also dynamically updates the adjusted room price into the room inventory record 218.

In comparison to the conventional room inventory management system 100, the room inventory management system 200 has the following advantages: (1) Overcome the overbooking issue by making sure that all the successful transactions are recorded in a chronological order; (2) Relieve the PMS module's loading, time and bandwidth in confirming successful transactions and/or updating room inventory records with the aid of the intermediate server system 250; and (3) Enhance correctness and traceability of room inventory records.

In the abovementioned embodiment, the room inventory management system 200 applies a central module, i.e., the transaction proxy server 260, to manage primary tasks among node servers NS1, NS2, . . . , NSX of the intermediate server system 260. However, another embodiment of the present invention better balances the managing tasks by shifting such managing responsibility between the node servers NS1, NS2, . . . , NSX. Specifically, anyone of the node servers NS1, NS2, . . . , NSX may be temporarily assigned to be a master node server to manage all the node servers NS1, NS2, . . . , NSX for a period of time, and another node server among the node servers NS1, NS2, . . . , NSX may be assigned to be a new master node server for another period of time. In some examples, the transfer of a master node server's responsibility between the node servers NS1, NS2, . . . , NSX can be performed from time to time, periodically, randomly. Also, the assignment of a master node server may be performed by an election, a sequential rotation, or a predetermined rule among the node servers NS1, NS2, . . . , NSX. The predetermined rule may include dynamically assigning a node server having a smaller or the smallest burden to be the master node server, where such burden may include an instant system loading, an instant size of storage, and/or an instant transmission bandwidth. Therefore, any of the node servers NS1, NS2, . . . , NSX can be avoided from taking an unaffordable burden and from even malfunctioning.

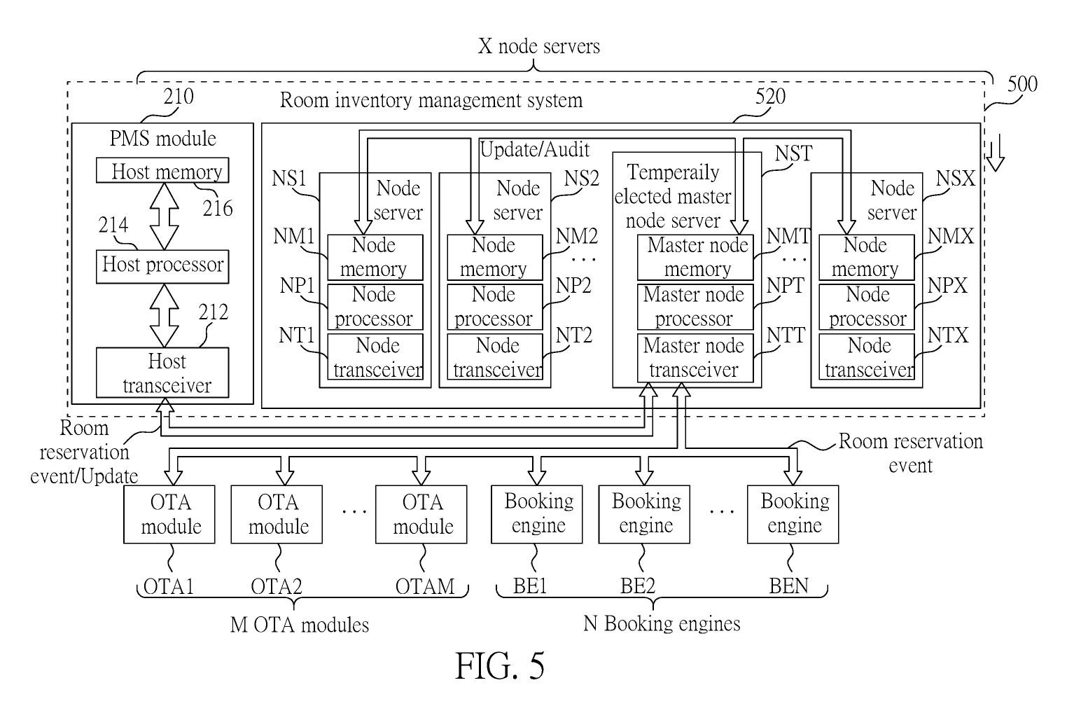

FIG. 5 illustrates a room inventory management system 500 according to another embodiment of the present invention. The room inventory management system 500 includes the PMS module 210 and an intermediate server system 520. The PMS module 210's property and disposition are the same as mentioned in FIG. 2. Such that introduction about the PMS module 210 is not repeatedly described. The intermediate server system 520 includes the plurality of node servers NS1, NS2, . . . , NSX that are the same as mentioned in FIG. 2. However, the primary difference between the room inventory managing systems 200 and 500 lies in that one of the node servers NS1, NS2, . . . , NSX can be temporarily elected to be a master node server for replacing the transaction proxy server 260, with the aid of a consensus algorithm. The master node server and its elements inherit at least the same structure and capabilities as those of the transaction proxy server 260 and its elements. Such that repeated descriptions of the master node server in view of the transaction proxy server 260 are skipped for brevity.

The consensus algorithm of electing the master node server among the node servers NS1, NS2, . . . , NSX may include a sequential order, a random order, and/or via a polling consensus involving all the node servers. An elected master node server takes the managing tasks for a predetermined period of time, and the election is held again to determine another master node server after the predetermined period of time ends, so that the previously-elected master node server can be relieved from its duty until it is elected again. The following descriptions are based on a condition that a node server NST is temporarily elected as a master node server that performs similar functions as those of the transaction proxy server 260.

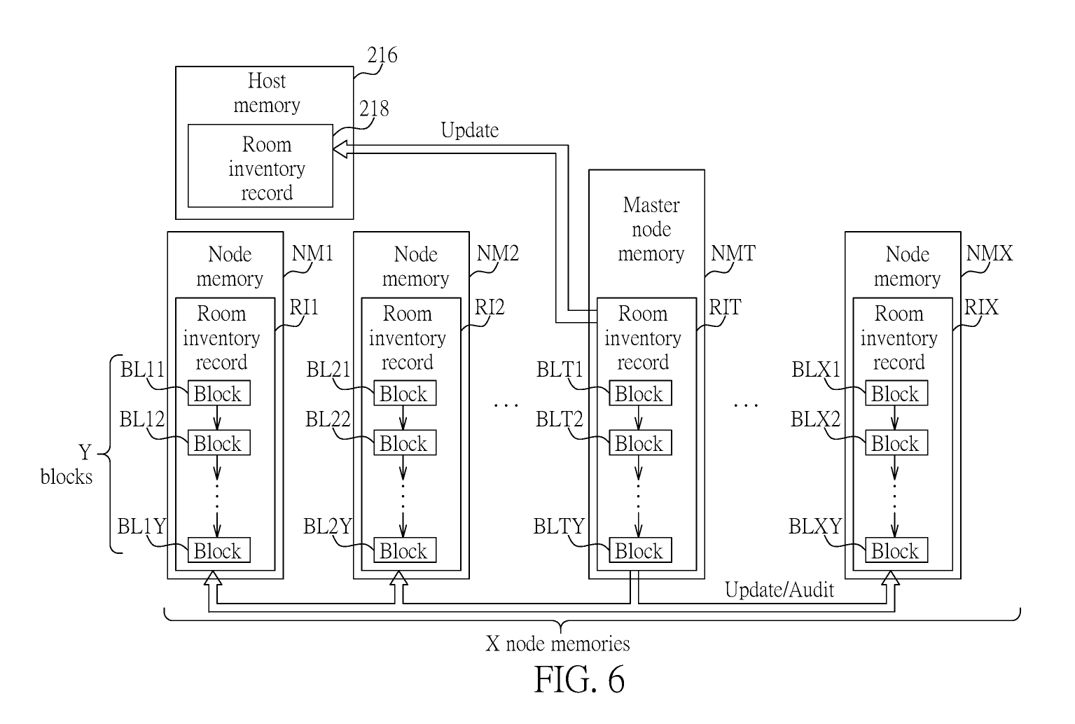

FIG. 6 illustrates a schematic diagram about relations between room inventory records of the host memory 216 and the other node memories NM1, NM2, . . . , NMX (including the temporary master node memory NMT), i.e., the room inventory record 218 and the room inventory records RI1, RI2, . . . , RIX (including the temporary master room inventory record RIT). Similarly, the room inventory records RI1, RI2, . . . , RIX are implemented using a plurality of smart contracts stored in the memories NM1, NM2, . . . , NMX. And the node processors NP1, NP2, . . . , NPT, . . . , NPX accesses and/or updates respective room inventory records RI1, RI2, . . . , RIX using the plurality of smart contracts. In some examples, the master node processor NST first updates the temporary master room inventory record RIT in response to occurrence of a successful transaction. Also, the master node processor NST forwards the updated contents of the temporary master room inventory record RIT to the PMS module 210 via the master node transceiver NTT and the host transceiver 212, such that the host processor 214 updates the room inventory record 218 to be substantially synchronous with the updated contents of the temporary master room inventory record RIT. The master node processor NPT also generates a new block that keeps at least all up-to-date successful transactions of the PMS module 212, in response to the updated contents of the master room inventory record RIT. It is also noted that the smart contracts stored in each of the node server NS1, NS2, . . . , NSX's memory NM1, NM2, . . . , NMT are similar as those stored in the intermediate memory 266. Therefore, in some examples, the master node processor NPT may load at least one smart contract stored in the master node memory NMT for executing complete instructions, such as calculating and updating variables, to generate the new block. For example, upon Y different successful transactions occurring in a chronological order, a preceding master node processor and/or the temporary master node processor 264 may generate a block BL1 at a moment t1, a block BL2 at a moment t2, . . . , and a most recently-generated block BLY at a moment tY, where Y is a positive integer. The moment t1 is earlier than the moment t2, the moment t2 is earlier than the moment t(Y−1), and the moment t(Y−1) is earlier than the moment tY. The moment tY indicates a most-recent successful transaction that occurs at the moment tY. The block BL1 includes all up-to-date successful transactions until the moment t1. The block BL2 includes one more successful transaction occurring at the moment t2 than the block BL1, i.e., the block BL2 includes all up-to-date successful transactions until the moment t2. Similarly, the block BLY includes all up-to-date successful transactions until the moment tY.

As mentioned previously, each of the node server NS1, NS2, . . . , NSX is required to keep respective room inventory records RI1, RI2, . . . , RIX synchronously updated with contents of a then-master room inventory record RIT under the blockchain technologies. Therefore, after receiving the most recent generated block BLY via respective node transceivers NT1, NT2, . . . , NTX (except for the then-master transceiver that transmits the most recent generated block BLY), the node processors NP1, NP2, . . . , NPX (except for the then-master node processor NPT) respectively incorporate the most recent generated block BLY into respective room inventory records RI1, RI2, . . . , RIX (except for the then-master room inventory record RIT). In some examples, the node processors NP1, NP2, . . . , NPX require at least one smart contract's assistance to synchronously execute instructions involved in the most recent transaction for completing the updates in respective room inventory records RI1, RI2, . . . , RIX. The updates may include, for example, updates of certain local variables, including room availabilities or respective room prices, or updates of certain global variables, including conditional discounts or a dynamically-adjusted room price.

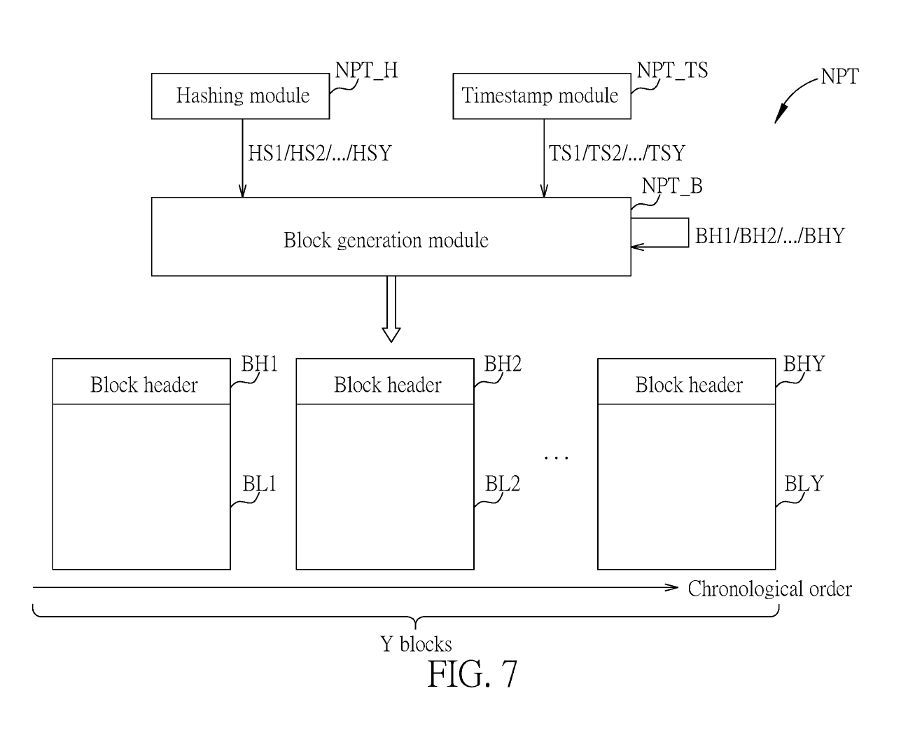

FIG. 7 illustrates how the temporary master node processor NPT generates a new block in detail. The temporary master node processor NPT includes a hashing module NPT_H, a timestamp module NPT_TS and a block generation module NPT_B. As mentioned before, the temporary master node processor NPT generates a new block in response to a successful transaction. Upon the temporary master node processor NPT confirms the successful transaction, the hashing module NPT_H generates a substantially unique hash value for the new block, and the timestamp module NPT_TS generates a substantially unique timestamp for the new block. For example, the hashing module NPT_H generates Y substantially unique hash values HS1, HS2, . . . , HSY, and the timestamp module NPT_TS generates Y substantially unique timestamps TS1, TS2, . . . , TSY respectively for the Y blocks BL1, BL2, . . . , BLY.

Similar with the previous embodiment, methods of generating a hash value are well known for those who are skilled in the blockchain technologies, therefore, such methods are not specifically introduced herein. Also, in some examples, the generated timestamp may be referred as the moment when the temporary master node processor NPT confirms the successful transaction or when the room reservation event is initiated, for example, by the PMS module 210 or anyone of the OTA modules OTA1, OTA2, . . . , OTAM and the booking engines BE1, BE2, . . . , BEN. In this way, each the block BL1, BL2, . . . , BLY should have its substantially unique hash value and substantially unique timestamp. And the most recently-generated block BLY has a latest timestamp among all the up-to-date generated blocks.

The block generation module NPT_B, in response to the successful transaction, incorporates the substantially unique hash value from the hashing module NPT_H and the substantially unique timestamp from the timestamp module NPT_TS for generating a block header. For example, the block generation module NPT_B incorporates the hash value HSY and the timestamp TSY to generate a block header BHY for the to-be-generated block BLY upon a most recent successful transaction. In this way, the block generation module NPT_B respectively generates block headers BH1, BH2, . . . , or BHY.

In addition, the block generation module NPT_B, in response to the successful transaction, generates a new block that incorporates a corresponding block header, contents of the successful transaction, at least one smart contract, and contents of a directly-preceding generated block. For example, in response to a most recent successful transaction, the block generation module NPT_B generates the block BLY that includes the block header BHY, at least one smart contract loaded from the temporary master node memory NTT, and contents of a directly-preceding block BL(Y−1) (not illustrated for brevity). In this way, the most recently-generated block BLY includes contents of all previously generated blocks BL1, BL2, . . . , BL(Y−1). Also, all up-to-date successful transactions indicated by all the previously generated blocks BL1, BL2, . . . , BL(Y−1) can be audited by just referencing the most recently-generated block BLY.

Last, the block generation module NPT_B adds the new block into the blockchain formed by the node servers NS1, NS2, . . . , NSX to update the blockchain. For example, the block generation module NPT_B adds the most recently-generated block BLY into the blockchain that already contains blocks BL1, BL2, . . . , BL(Y−1) for updating the blockchain.

Similar as the room inventory management system 200, the room inventory management system 500 has substantially the same alternative embodiments, properties and advantages, as introduced in descriptions about the room inventory management system 200. Additionally, the responsibility of serving as the master server node is shifted between the node servers NS1, NS2, . . . , NSX from time to time, randomly, periodically or by following a predetermined rule that balances the master node's responsibility. Therefore, the node servers NS1, NS2, . . . , NSX can better balance respective loadings and avoid undesired malfunctioning.

One skill in the art understands that the search method associated with the application is similar to the search method in the context of the apps, which was described in detail previously. Therefore, all the embodiments, methods, systems and components relating to apps apply to applications.

I/We claim:

1. A blockchain-based room inventory management system, comprising:
a property management system, comprising:
a host transceiver, configured to receive a successful transaction;
a host non-volatile computer-readable memory, configured to store a copy of a room inventory record that records availability of all rooms managed by the property management system; and
a host computer processor, configured to update the copy of the room inventory record by incorporating the successful transaction;
an intermediate server system, comprising:
a transaction proxy server, comprising:
an intermediate transceiver, configured to receive a room reservation event, configured to forward the successful transaction to the property management system, and configured to forward a new block generated in response to the successful transaction;
an intermediate non-volatile computer-readable memory, configured to store a plurality of smart contracts generated based on Ethereum, configured to store the room inventory record that is implemented using at least one of the plurality of smart contracts, and configured to store a blockchain that comprises a plurality of blocks, wherein a most recently added block of the blockchain carries all up-to-date successful transactions of the property management system;
an intermediate computer processor, configured to confirm if the room reservation event will introduce overbooking in the room inventory record, and configured to determine that the room reservation event is successful and generate the successful transaction using information of the room reservation event when the intermediate computer processor confirms that the room reservation event will not introduce overbooking in the local room inventory record, wherein the intermediate computer processor comprises:
a hashing module, in response to the successful transaction, configured to generate a hash value for the new block;
a timestamp module, in response to the successful transaction, configured to generate a unique timestamp for the new block; and
a block generation module, in response to the successful transaction, configured to generate a unique block header for the new block using at least the unique hash value, the unique timestamp and contents of the most recently added block, configured to generate the new block that comprises the unique block header, the information of the successful transaction, at least one of the plurality of smart contracts and the contents of the most recently added block, and configured to add the new block in the blockchain; and
a plurality of node servers, each of the node server comprising:
a node transceiver, configured to receive the new block from the intermediate transceiver;
a node non-volatile computer-readable memory, configured to store a copy of the blockchain; and
a node computer processor, configured to update the copy of the blockchain by adding the new block to the copy of the blockchain.

2. The blockchain-based room inventory management system of claim 1, wherein the timestamp module is further configured to generate the unique timestamp based on an issuance time of the room reservation event.

3. The blockchain-based room inventory management system of claim 1, wherein the timestamp module is further configured to generate the unique timestamp based on a receiving time when the intermediate transceiver receives the room reservation event.

4. The blockchain-based room inventory management system of claim 1,
wherein the intermediate computer processor is further configured to, in response to the successful transaction, decrease a temporary available room amount and/or deactivate availability of a to-be-assigned room that is recorded in the room inventory record when the room reservation event comprises a room reservation request that instructs to reserve the to-be-assigned room; and
wherein the intermediate computer processor is further configured to, in response to the successful transaction, increase the temporary available room amount and/or activate availability of a to-be-released room that is recorded in the room inventory record and the at least one room inventory managing smart contract when the room reservation event comprises a room reservation cancelling request that instructs to cancel a room reservation of the to-be-released room or a room checkout request that instructs to checkout the to-be-released room.

5. The blockchain-based room inventory management system of claim 4, wherein the host computer processor is further configured to, in response to the successful transaction, decrease a local available room amount and/or deactivate availability of the to-be-assigned room recorded in the copy of the room inventory record when the room reservation event comprises the room reservation request; and
wherein the host computer processor is further configured to, in response to the successful transaction, increase the local available room amount and/or activate availability of the to-be-released room recorded in the copy of the room inventory record when the room reservation event comprises the room reservation cancelling request or the room checkout request.

6. The blockchain-based room inventory management system of claim 1, wherein the plurality of smart contracts comprises at least one dynamic pricing smart contract;
wherein the intermediate computer processor is further configured to, according to a temporary available room amount recorded in the room inventory record, dynamically adjust a temporary room price recorded in the room inventory record and dynamically forward the temporary room price to the property management system, an online travel agency (OTA) module, a booking engine, a global distribution system, or a metasearch engine via the intermediate transceiver.

7. The blockchain-based room inventory management system of claim 6, wherein the host computer processor is further configured to dynamically update a local room price recorded in the host non-volatile computer-readable memory using the temporary room price when the host transceiver receives the temporary room price.

8. The blockchain-based room inventory management system of claim 1, wherein the plurality of smart contracts comprise at least one auditing smart contract;
wherein the intermediate computer processor or anyone of the node processor is further configured to use the at least one auditing smart contract to audit at least one successful transaction recorded in at least one block of the blockchain by tracing block headers of the at least one block in a chorological manner.

9. The blockchain-based room inventory management system of claim 1, wherein the property management system and the intermediate server system shares a same remote procedure call (RTC) procedure for mutual communication.

10. The blockchain-based room inventory management system of claim 1, wherein the intermediate computer processor is further configured to apply at least one of the plurality of smart contracts to generate a common application programming interface (API) and/or a common communication protocol, such that anyone of a booking engine, an OTA module, a global distribution system, or a metasearch engine can use the common API and/or the common communication protocol to initiate the room reservation event and/or check the room inventory record of anyone of the plurality of node servers.

11. A blockchain-based room inventory management system, comprising:
a property management system, comprising:
a host transceiver, configured to receive a successful transaction;
a host non-volatile computer-readable memory, configured to store a copy of a room inventory record that records availability of all rooms managed by the property management system; and
a host computer processor, configured to update the copy of the room inventory record by incorporating the successful transaction; and
an intermediate server system, comprising:
a plurality of node servers, each of the node servers comprising:
a node transceiver, configured to receive a room reservation event, configured to forward the successful transaction to the property management system, and configured to forward a new block generated in response to the successful transaction;
a node non-volatile computer-readable memory, configured to store a plurality of smart contracts generated based on Ethereum, and configured to store a blockchain that comprises a plurality of blocks or store a copy of the blockchain, wherein a most recently added block of the blockchain carries all up-to-date successful transactions of the property management system, and wherein the room inventory record is implemented using at least one of the plurality of smart contracts; and
a node computer processor, configured to update the stored blockchain or the stored copy of the blockchain by adding a new block to the stored blockchain or the stored copy of the blockchain, the node computer processor comprises a hashing module, a timestamp module and a block generation module;
wherein the plurality of node servers are configured to temporarily elect a master node server among themselves using a consensus algorithm;
wherein the node computer processor of the master node server is further configured to confirm if the room reservation event will introduce overbooking in the room inventory record, and configured to determine that the room reservation event is successful and generate the successful transaction using information of the room reservation event when the node computer processor of the master node server confirms that the room reservation event will not introduce overbooking in the room inventory record;
wherein the hashing module of the master node server is configured to generate a hash value for the new block in response to the successful transaction;
wherein the timestamp module of the master node server is configured to generate a unique timestamp for the new block in response to the successful transaction;
wherein the block generation module of the master node server is configured to, in response to the successful transaction, generate a unique block header for the new block using at least the unique hash value, the unique timestamp and contents of the most recently added block, generate the new block that comprises the unique block header, the information of the successful transaction, at least one of the plurality of smart contracts and the contents of the most recently added block, and add the new block in the blockchain stored in the node non-volatile computer-readable memory of the master node server;
wherein the block generation module of the node computer processor of the plurality of node servers other than the master node server, in response to the successful transaction, is configured to add the new block in the copy of the blockchain stored in respectively node non-volatile computer-readable memory.

12. The blockchain-based room inventory management system of claim 11, wherein the timestamp module is further configured to generate the unique timestamp based on an issuance time of the room reservation event.

13. The blockchain-based room inventory management system of claim 11, wherein the timestamp module is further configured to generate the unique timestamp based on a receiving time when the node transceiver of the master node server receives the room reservation event.

14. The blockchain-based room inventory management system of claim 11, wherein the plurality of smart contracts comprises at least one room inventory managing smart contract that stores the room inventory record;
wherein the node computer processor of the master node server is further configured to, in response to the successful transaction, decrease a temporary available room amount or deactivate availability of a to-be-assigned room that is recorded in the room inventory record when the room reservation event comprises a room reservation request that instructs to reserve the to-be-assigned room; and
wherein the node computer processor of the master node server is further configured to, in response to the successful transaction or an internal checkout request, increase the temporary available room amount and/or activate availability of a to-be-released room that is recorded in the room inventory record when the room reservation event comprises a room reservation cancelling request that instructs to cancel a room reservation of the to-be-released room or a room checkout request that instructs to checkout the to-be-released room.

15. The blockchain-based room inventory management system of claim 14, wherein the host computer processor is further configured to, in response to the successful transaction, decrease a local available room amount and/or deactivate availability of the to-be-assigned room recorded in the copy of the room inventory record when the room reservation event comprises the room reservation request; and
wherein the host computer processor is further configured to, in response to the successful transaction, decrease the local available room amount and/or activate availability of the to-be-released room recorded in the copy of the room inventory record when the room reservation event comprises the room reservation cancelling request or the room checkout request.

16. The blockchain-based room inventory management system of claim 11, wherein the plurality of smart contracts comprises at least one dynamic pricing smart contract that stores the room inventory record;
wherein the node computer processor of the master node server is further configured to, according to a temporary available room amount recorded in the room inventory record, dynamically adjust a temporary room price recorded in the room inventory record and dynamically forward the temporary room price to the property management system, an online travel agency (OTA) module, a booking engine, a global distribution system, or a metasearch engine via the node transceiver.

17. The blockchain-based room inventory management system of claim 16, wherein the host computer processor is further configured to dynamically update a local room price recorded in the copy of the room inventory record stored in the host non-volatile computer-readable memory using the temporary room price.

18. The blockchain-based room inventory management system of claim 11, wherein the plurality of smart contracts comprise at least one auditing smart contract;
wherein the node computer processor of the plurality of node servers is further configured to use the at least one auditing smart contract to audit at least one successful transaction recorded in at least one block of the blockchain by tracing block headers of the at least one block of the blockchain in a chronological manner.

19. The blockchain-based room inventory management system of claim 11, wherein the property management system and the intermediate server system shares a same RTC procedure for mutual communication.

20. The blockchain-based room inventory management system of claim 11, wherein the room reservation event is transmitted from a booking engine, an OTA module, a global distribution system, or a metasearch engine; and
wherein the master computer processor is further configured to apply at least one of the plurality of smart contracts to generate a common API and/or a common communication protocol, such that anyone of a booking engine, an OTA module, a global distribution system, or a metasearch engine can use the common API and/or the common communication protocol to initiate the room reservation event and/or check the room inventory record of anyone of the plurality of node servers.

21. The blockchain-based room inventory management system of claim 11, wherein the plurality of node servers are further configured to use the consensus algorithm to determine the master node server among the plurality of node servers by an election, a sequential rotation, or a predetermined rule.

22. The blockchain-based room inventory management system of claim 21, wherein under the predetermined rule, the plurality of node servers are further configured to dynamically assign a node server having a smaller or the smallest burden to be the master node server; and
wherein the burden is determined by an instant system loading, an instant size of storage, and/or an instant transmission bandwidth of the plurality of node servers.
